(19) United States
(12) Patent Application Publication
(10) Pub. No.: US 2011/0107890 A1
(43) Pub. Date: May 12, 2011

(54) Machine Tool, especially Handheld Machine Tool

(76) Inventors: Thilo Koeder, Gerlingen (DE); Joachim Platzer, Remseck-Hochberg (DE)

(21) Appl. No.: 13/002,321

(22) PCT Filed: May 4, 2009
(86) PCT No.: PCT/EP2009/055338

§ 371 Date: Jan. 20, 2011

(30) Foreign Application Priority Data
Jul. 2, 2008 (DE) 10 2008 040 071.8

(51) Int. Cl. B23D 51/00; B26D 7/18; G02B 27/00

(52) U.S. Cl. 83/358; 83/520; 30/516

(57) ABSTRACT

The invention relates to a machine tool (1), especially a machine tool designed as a handheld jigsaw (2), wherein an optical device (33; 59), the window (30) of which is associated with a protective system (35) against soiling and/or damage, is provided for the working field (9) of said machine tool and/or for a working line (27) in the detection surface (10) of said machine tool as a path specification.

The invention relates to a machine tool, in particular a handheld machine tool, according to the precharacterizing clause of claim 1.

### PRIOR ART

In the case of machine tools, in particular handheld machine tools, and in this case especially jigsaws, the user's view of the workpiece-side working area of the working tool of the machine tool is frequently restricted by handling and/or by the design. This exacerbates the work and can also adversely affect the work results. For this reason, auxiliary devices are used, for example illumination devices in order to improve at least the visibility conditions in the working area. Furthermore, observation devices are also used, which are intended to allow indirect observation of the working area.

Optical arrangements such as these require a window which is aligned with the working area in the vicinity thereof, and a corresponding arrangement of this window. However, even a small window area in the vicinity of the working tool results in situations, as a result of particles being thrown off the workpiece, dust particles and dirt particles, irrespective of whether these are caused by damage or dirt, which adversely affect the visibility conditions in the area of the window surface.

### DISCLOSURE OF THE INVENTION

The invention is based on the object of avoiding such circumstances adversely affecting the visibility conditions in the case of machine tools of the type mentioned initially.

According to the invention, this object is achieved by the features of claim 1. The dependent claims specify expedient developments.

The invention operates with a protection system for the window. The term window means not only a separate, transparent cover, for example for an illumination source or a sensor system such as a camera, but, in particular, also the light output surface of a lighting body or the optics of a sensor system, for example the objective of a camera.

It is particularly expedient for a protection system such as this to be a system which operates on the basis of self-cleaning effects. In particular, covers or light output surfaces with self-cleaning surfaces can be used for this purpose, for example microstructured surfaces, surfaces which can be wet only to a minor extent, as well as surfaces which are sealed in an appropriately dirt and/or water-repellent form, for example nanosealing.

Such seals can also, per se, form protection for the respective window against damage and may possibly have sealing materials with good resistance added to them for this protection purpose, which do not adversely affect the transparency—similar to clear lacquers.

Corresponding self-cleaning effects can also be achieved by high-frequency oscillations and shaking movements, for example by excitations in the ultrasound range, thus counteracting dirt deposits. Such measures can also advantageously be used, in particular, in addition to corresponding surface structuring, sealing and the like.

Furthermore, it is also within the scope of the invention, and in particular also in addition to the measures described above, for the protection system to be in the form of an air-assisted system, for example by using a sheath and/or a nozzle to ensure that a flow passes around or over the respective surface to be protected.

The amounts of air required for this purpose can be tapped off without any additional energy consumption from the cooling air flow which is required to cool the drive motor of the machine tool, in which case it may be expedient to pass the component of the air that has been tapped off via an intermediate cleaning device, and/or to also, if required, add a cleaning agent to this air component, which cleaning agent at least makes it harder for dirt to adhere once again, preferably also by appropriate wetting.

Further protection systems which can be used within the scope of the invention also include covering the window with films, in particular films which can be pulled off, as a result of which the visibility conditions can once again be improved in each case by replacing the film when it becomes correspondingly dirty.

The invention is particularly important in conjunction with machine tools which allow a respective working line to be followed semi-automatically by the working tool of the machine tool during working operation, but which are dependent for this purpose on accurate detection of the working line since, when working semi-automatically in this way, the user just supports the machine, but does not guide it. For such semi-automatic operation, the working line is detected via a sensor system, preferably a camera, and the detected characteristic data relating to the working line is also passed via a signal processing unit to a control and actuating unit, via which the working tool of the machine tool, that is to say the saw blade in the case of a jigsaw, is guided such that it is aligned with the working line.

Further details and features of the invention will become evident from the claims, the description and the drawings. In the latter:

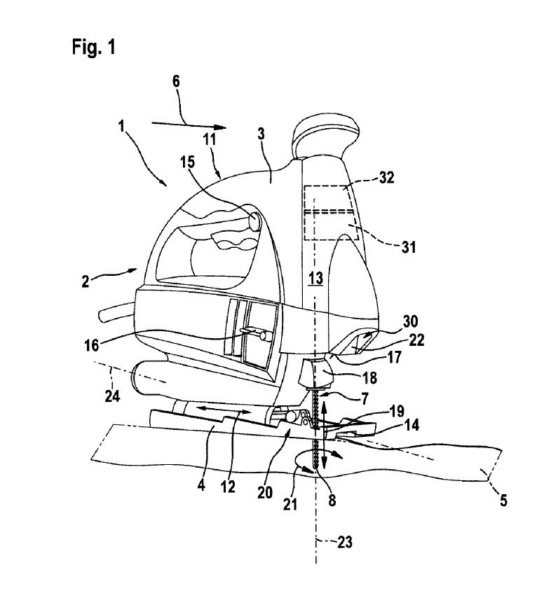

FIG. 1 shows, schematically, a perspective side view of a jigsaw as an example of a handheld machine tool which is provided with an optical arrangement which has a window facing the workpiece-side working surface of the working tool, and is operated in a number of operating modes,

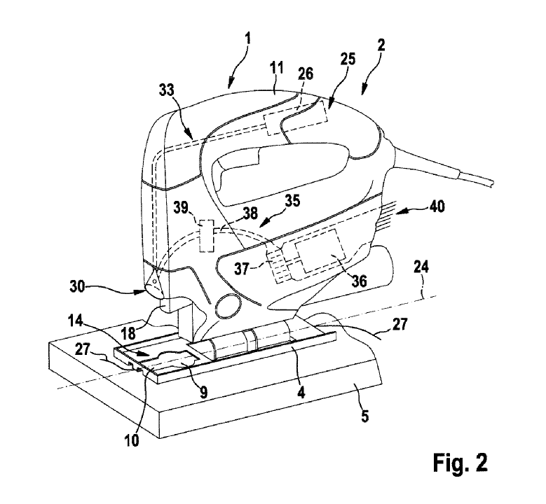

FIG. 2 shows a further-simplified and schematic side view of a jigsaw, with a corresponding basic design, illustrating the protection system associated with the window,

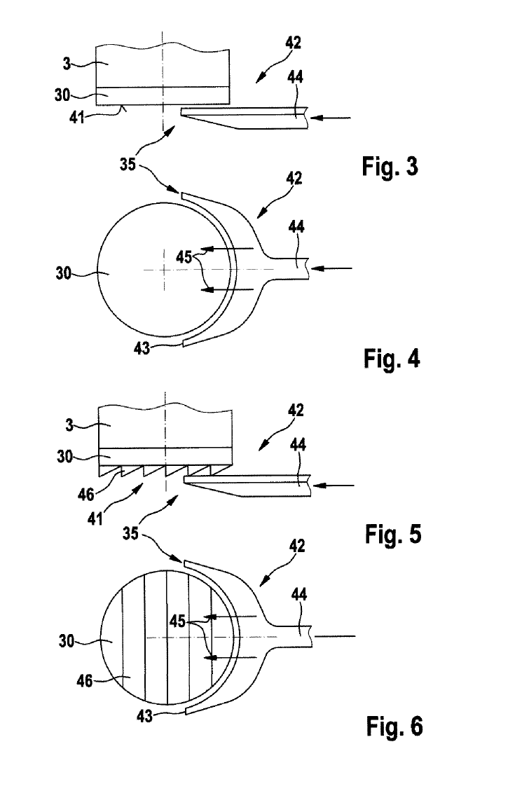

FIGS. 3 to 10 show various variants for embodiments of a protection system associated with the window, and

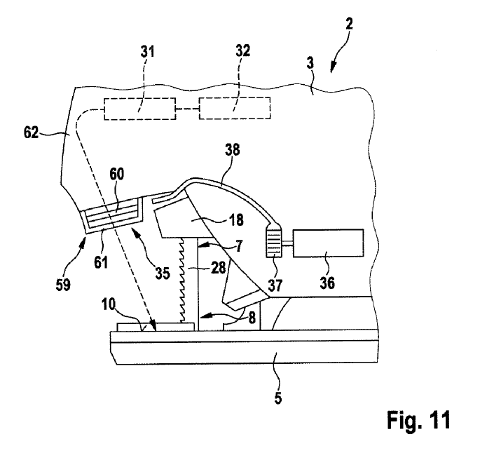

FIG. 11 shows a further design variant of a jigsaw, shown in detail with the protection system which is associated with the window and comprises a cover.

As an example of a machine tool 1, FIG. 1 shows a jigsaw 2 which is supported via a base plate 4 on a workpiece 5. The jigsaw 2 has a saw blade 8, which is driven with a reciprocating-movement in the direction of the arrow 19, as a working tool 7, in the front area of the jigsaw 2, with respect to the working direction 6, and the housing of the jigsaw 2 is annotated 3. The associated reciprocating-movement drive is arranged in the area of the housing 3 above this, whose end wall 13 ends in a step 17 in the direction of the saw blade holder 18, which step 17 overlaps the saw blade 18 on the saw blade holder 18, and in whose junction to the end wall 13 the window 30 is located, for an optical arrangement 33 which is illustrated as an example in FIG. 2. In the observation direction, the window 30 is located opposite the workpiece-side working area 9 of the saw blade 8, with a corresponding cutout 14 on the side of the baseplate 4, through which the saw blade 8 passes. The optical arrangement 33 may also have a lighting arrangement 22, and it may also have a window 30 in a corresponding manner to this. This is indicated in FIG. 1.

FIG. 1 furthermore shows the saw blade 8 aligned correspondingly to its straight-ahead working direction, which corresponds to the normal operating mode of the jigsaw 2. The flat faces 28 of the saw blade 8 extend therein (see FIG. 11) in the direction of the longitudinal axis 24 of the jigsaw 2. Furthermore, the jigsaw 2 can be operated in further operating modes, one of which is the so-called oscillating reciprocating-movement mode, in which the saw blade 8 is driven in an oscillation direction (arrow 12), via the actuating drive 20, superimposed on the reciprocating-movement drive (arrow 19). A further, third operating mode is indicated by the arrow 21, according to which the saw blade 8 can be moved about its rotation axis 23 to rotation positions at an angle to the longitudinal axis 24, from its extent corresponding to the straight-ahead working direction. This third operating mode represents the so-called scrolling mode, in which the saw blade 8 is aligned by movement of its rotation axis 23 to a working line 27, which differs from the profile of the longitudinal axis and is indicated in FIG. 2, and follows this working line 27.

A working direction which differs from the longitudinal alignment (longitudinal axis 24) of the jigsaw 2 can thus be achieved, corresponding to the rotation position of the saw blade 8. In the scrolling mode, when the sensors detect a respective working line 27, its profile is converted with computer assistance to actuating commands for an actuator system, by means of which the saw blade 8 is set to the respective rotation position corresponding to the profile of the working line 27. In a corresponding manner to this automatic following of the respective working line 27, varying the rotation position of the saw blade 8 results in a semi-automatic working mode, in which the user who is holding the jigsaw 2 essentially just has to provide the forward movement for the jigsaw 2 and to support the jigsaw 2—aligned roughly—in the direction of the respective working line 27. However, the working line 27 is followed directly by the machine alignment of the saw blade 8, which is guided transversally because of its flat shape, on the working line 27, and along the working line 27.

The jigsaw 2 is set to the various operating modes via a switching device 16. Furthermore, a circuit arrangement is indicated at 15, by means of which the jigsaw 2 can be switched on and off. The observation device which is required for semi-automatic operation of the jigsaw 2, together with the associated optical arrangement 33, interacts, as is also indicated in FIG. 1, with a computation unit 31 and a control and actuating unit 32. The actuating unit 32 accesses the saw blade 8 via an appropriate actuator system, in order to set the respectively required rotation angle position.

In addition to the already mentioned machine-side preconditions, the respective working line 27 must also be detected accurately in order to allow the saw blade 8 to exactly follow the working line 27. Starting from the window 30, this requires an unobstructed view of a detection area 10, which is adjacent to the working area 9, is bounded by the cutout 14 and is indicated in FIG. 2, and through which the working line 27 in each case runs.

In a similar manner to that in FIG. 1, FIG. 2 only indicates the window 30 as such, and its position with respect to the detection area 10. This also applies to the dashed-dotted representation of the optical arrangement 33, which is based on the sensor system 25, which is in the form of a camera 26 and is arranged, for example, in the handle part 11 of the jigsaw 2. FIG. 2 also shows a first embodiment of a protection system 35, in the form of dashed lines, ending at the window 30, and which is used to prevent the window 30 from becoming dirty, in which case the protection system 35 operates with air assistance, using purging air which is tapped off from the cooling air flow for the drive motor 36. The cooling air is fed via a fan 37, which is indicated and from which a line connection leads into the area of the window 30, which is intended to be prevented from becoming dirty by the purging air. In a corresponding manner, it has been found to be expedient for a cleaning and/or separating apparatus 39 to be integrated in the line connection 38, which separates impurities contained in the purging air, since the purging air, which is extracted in the vicinity of the jigsaw 2, is generally at least loaded with dust corresponding to the working conditions. The means for sucking air into the fan 37 are indicated by air openings 40 which are provided in the housing 3.

FIG. 2 roughly shows one possible way according to the invention to at least reduce dirt deposits on the window 30, by blowing on it or by blowing them off, in particular also by blowing purging air onto the window 30, or blowing off, suddenly and/or in an increasing and decreasing manner, in which case the window 30 can be used as a window-like cover for a downstream sensor system, optics or the like, and therefore also as a protective cover. However, the window 30 may also be formed by the outer face 41 of these optics or this sensor system, for example by an objective or a lens system.

FIGS. 3 to 10 illustrate, in some cases, design refinements of a solution such as this, in some cases additionally or else solutions which can be used autonomously as protection systems.

For example, FIGS. 3 and 4 show that the window 30, which is illustrated as having been inserted into the housing 3, has air blown onto it, preferably approximately tangentially, on its outer face 41 which is subject to becoming dirty and faces the working area 9, to be precise via a blowing nozzle 42, which is in the form of a flat nozzle and extends in an approximately semicircular shape with respect to the window 30, which in the example is circular. The outlet cross section 43 of the nozzle 42 is in the form of a blowing gap which is supplied with purging air by virtue of the size of its cross section and/or the size and/or configuration of the rearward part of the nozzle 42, which is connected to the purging air connection 44, so as to create a focused air flow, which is as uniform as possible, over the area of the window 30.

FIGS. 5 and 6 are based on the same basic configuration for a nozzle 42, as a result of which reference can be made in this context to the statements relating to FIGS. 3 and 4. Furthermore, FIGS. 5 and 6 show structuring of the outer face 41 of the window which the air flow is blown onto, symbolically represented by ribs 46 which run transversally with respect to the blowing direction, are like saw teeth, and rise in the blowing direction. The ribs 46 can also be split into individual rib sections and/or can be formed by guide bodies whose individual rib sections are offset with respect to one another, in each case with the aim, in conjunction with the flow being blown specifically in the blowing direction 45, of causing the purging air which flows over the outer face 41 to be swirled, preventing dirt particles from being attached to the outer face 41.

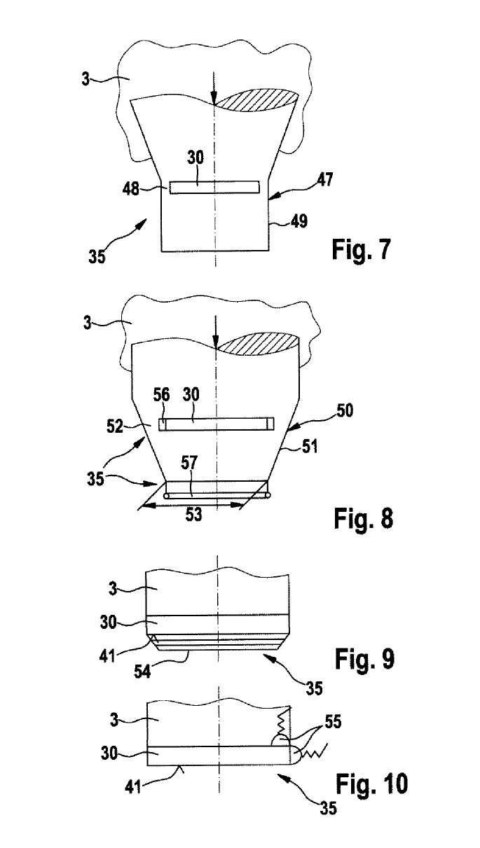

FIGS. 7 and 8 show solutions in which the window 30 is surrounded by an annular nozzle 47 through which purging air flows, to be precise surrounded at a distance, such that the purging air flows through an annular gap 48 between the nozzle 47 and the window 30 and effectively builds up a column of air, composed of cleaned purging air, moving in the flow direction, in the outlet-flow direction in front of the window 30, which counteracts accumulation of dirt particles on the outer face 41 of the window 30. For this purpose, it is expedient for the casing 49 of the nozzle 47 to project beyond the window 30 in the outlet flow direction, thus forming a protective shield which assists the process of building up a corresponding, flowing air cushion.

While in FIG. 7, the casing 49 runs virtually cylindrically with respect to the window 30, starting from the annular gap 48, FIG. 8 shows a variant in which the nozzle 50 has a casing 51 which tapers in the outlet-flow direction in the coverage area to the window 30, but at least in the area adjacent to the window 30 in the outlet-flow direction, thus forming a reversed funnel as the starting point with respect to the working surface. The funnel-shaped taper is chosen in the exemplary embodiment such that it results in an annular gap 52 having a relatively broad cross section, and such that the outlet cross section 53 of the nozzle corresponds approximately to the diameter of the window 30. For example, if the window 30 is in the form of an objective, which results in an optical beam in the direction of the working surface 9, then the outlet cross section can be tapered further, corresponding to the focusing and corresponding to the axial overhang with respect to the window 30, in comparison to the embodiment shown in FIG. 7, not only restricting the inlet cross section for any dirt particles and other particles, which could lead to damage to the window 30, but also contributing to the air flow being speeded up in the outlet-flow direction, thus resulting in the protection against dirt being improved further.

FIG. 9 shows an embodiment in which at least one tear-off film 54, and preferably a stack of tear-off films 54 is or are applied to the outer face 41 of the window 30, which can be pulled off when correspondingly dirty. Such dirt and damage protection can also be used, for example, in conjunction with solutions shown in FIGS. 7 and 8.

Furthermore, this also applies to the configuration of the protection system illustrated in FIG. 10 such that the window 30 is caused to oscillate, in particular to oscillate in the ultrasound range, and this can be achieved by oscillation exciters 55 which are fitted to the window 30. An embodiment such as this has additionally been found to be helpful in conjunction with embodiments as shown in FIGS. 3 to 6.

Dust can also be deposited by ionization, in the same way as in the case of the cleaning and separation apparatuses 39, and such effects can also be used in conjunction with keeping the window 30 free of dirt, for example by forming an electric field in the outlet area of the nozzle 47 or 50 as shown in FIGS. 7 and 8, respectively, by means of which dust and dirt particles are kept away from the window 30 by, for example, charging with the same polarity a frame 56 for the window 30 and a conductor ring 57 on the output side with respect to the nozzle 50.

Furthermore, it is within the scope of the invention, although this is not shown in the drawings, for the outer face 41 of the window 43 to in each case be configured in the surface structure and/or by coating such that no dirt adheres, or this is at least made very difficult, for example by using the known lotus effect.

Based on a jigsaw 2 with a corresponding design to that shown in FIG. 1, FIG. 11 shows an optical arrangement 59 in which the window 30 is formed by a line-scanning sensor system 60, in the form of a camera, and a cover 61 associated with it, in which case the cover 61 for the sensor 60 bounds or can bound a closed area, which may be closed off in an air-tight manner, such that the line-scanning sensor system 60 is protected against dirt and damage, and dirt on the cover can be counteracted by all those measures which have been explained with reference to the above exemplary embodiments. If required, the area bounded by the cover 61 with respect to the sensor 60 can also be subjected to an increased pressure, in order to prevent the ingress of contaminated air. The supply of cleaned compressed air can be provided for this purpose, for example by a connection to the fan 37, and, for example, restricting outlet-flow openings can be provided in the cover 61. The boundaries to the area, that is to say in particular the cover and/or the sensor 60, can also be designed and/or coated to repel dirt, in order to avoid the accumulation of residual dirt when pressure is applied to the area.

FIG. 11 shows that sensitive sensor systems can thus also be arranged in an exposed position with respect to the working tool 7, in this case formed by the saw blade 8, especially in an exposed position, as is shown in FIG. 11, resulting in a particularly advantageous observation position for the detection area 10, and if required also the working area 9 in its totality. In FIG. 11, the window 30 with the line-scanning sensor system 60 and the cover 61 is arranged on a front projection, like a nose, on the housing 3 of the jigsaw 2, projecting on the underneath in the direction of the working area 9 with respect to the nose-like projection 62, thus also resulting in the best preconditions for air purging. A line-scanning sensor system 60 such as this, which in particular also allows precise, high-resolution display of the detection area 10 and of the working line 27, is particularly worthwhile for jigsaws 2 which, as explained with reference to FIG. 1, can also in particular be used in a semi-automatic mode and are therefore reliably dependent on accurate observation of the detection area 10 and working line 27 solely via the optics.

1. A machine tool, comprising:
a working tool; and
an optical arrangement having a window which is located in the vicinity of a workpiece-side working area of the working tool; and
a protection system configured to protect the window against dirt and/or damage.

2. The machine tool as claimed in claim 1, wherein:
the protection system is configured to operate on the basis of self-cleaning effects.

3. The machine tool as claimed in claim 1 wherein:
the window includes an outer surface, and
the protection system includes a self-cleaning surface structure is provided on the outer face of the window.

4. The machine tool as claimed in claim 1, wherein:
the protection system includes a system configured to operate with purging air, using purging, dam and/or flow and/or oscillation effects.

5. The machine tool as claimed in claim 4, wherein:
the protection system includes an air-assisted system, configured to operate with at least one of the following: an annular nozzle, a sheath, and a blowing nozzle.

6. The machine tool as claimed in claim 4, wherein:
the protection system further includes a separating apparatus positioned in a flow of the purging air.

7. The machine tool as claimed in claim 4, further comprising:
a cleaning apparatus configured to add at least one cleaning additive to the purging air.

8. The machine tool as claimed in claim 6, wherein:
the separating apparatus includes one of the following: a filter body, a cyclone separator, and an electrical filter.

9. The machine tool as claimed in claim 1, wherein:
the protection system includes a replaceable cover which is located adjacent to the window.

10. The machine tool as claimed in claim 9, wherein the cover includes a coating applied to the window.

11. The machine tool as claimed in claim 9, wherein the cover includes a film removably attached to the window.

12. The machine tool as claimed in claim 1, wherein:
the optical arrangement has a sensor system, and
the protection system includes a cover located in front of the sensor system.

13. The machine tool as claimed in claim 1, wherein the optical arrangement includes a sensor system, further comprising:
a computation unit configured to record characteristic data sensed by the sensor system of a working line used as a working path, and
a control and actuating unit located downstream from the sensor system and configured to process the characteristic data,
wherein a sawing direction of the working tool is adjusted such that the sawing direction of the working tool coincides with the working line in response to processing the characteristic data by the control and actuating unit.

14. The machine tool as claimed in claim 1, wherein:
the window includes an outer surface, and
the protection system includes a coating provided on the outer surface of the window.

15. The machine tool as claimed in claim 1, wherein:
the window includes an outer surface, and
the protection system includes an oscillation exciter configured to oscillate at least a portion of the window.

16. The machine tool as claimed in claim 1, wherein:
the optical arrangement has a camera, and
the protection system includes a cover located in front of the camera.
